(19) United States
(12) Patent Application Publication
(10) Pub. No.: US 2026/0368828 A1
(43) Pub. Date: Nov. 19, 2026

(54) METHODS, SYSTEMS, APPARATUSES, AND DEVICES FOR FACILITATING MANAGING INSURANCES FOR INDIVIDUALS, RISK PROFILE FOR INDIVIDUALS/HOUSEHOLD, AND RISK COMPLIANCE

(71) Applicants: Priyadarshni Palanimuthu, Galena, OH (US); DHRUPTI PATEL, BRIDGEWATER, NJ (US); SANDHYA RAO POCHIRAJU, NEWPORT, RI (US)

(72) Inventors: Priyadarshni Palanimuthu, Galena, OH (US); DHRUPTI PATEL, BRIDGEWATER, NJ (US); SANDHYA RAO POCHIRAJU, NEWPORT, RI (US)

(21) Appl. No.: 19/753,887

(22) Filed: Jul. 24, 2026

Related U.S. Application Data
(63) Continuation-in-part of application No. 17/352,827, filed on Jun. 21, 2021, now abandoned.

(51) Int. Cl. G06Q 40/08; G06V 30/14

(52) U.S. Cl. CPC G06Q 40/0822; G06Q 40/0842; G06Q 40/09; G06V 30/14; G06Q 2220/00

(57) ABSTRACT

A system and method for facilitating insurance management comprising: receiving individual information from user devices; analyzing the information via machine learning models to generate a risk profile and determine insurance requirements; identifying matching insurance providers and brokers; establishing secure communication links with selected providers and brokers; receiving and executing insurance operations; generating and storing resulting insurance documents and associated data in an encrypted vault.

### FIELD OF THE INVENTION

Generally, the present disclosure relates to the field of data processing. More specifically, the present disclosure relates to methods, systems, apparatuses, and devices for facilitating managing insurances for individuals.

### BACKGROUND OF THE INVENTION

Insurance is often overlooked by many of us, and it is looked upon as a tax through life's journey providing no material day-to-day value but only in times of a crisis. Digital pioneers such as Amazon and eBay have set new standards for convenience, speed, value, and ease of use. Consumers, particularly the millennials, now want an intuitive experience whether they're buying a car, opening a bank account, or shopping for an insurance policy. The disruption in the user experience space is forcing insurers and brokers to rethink their strategy for customer interaction.

Existing insurance practices are deficient with regard to several aspects. Insurance is not “attractive” to the consumer, not like talking to a financial advisor. Insurance is looked upon as a tax and not an investment, and consumers don't understand the importance of insurance until it's too late. Insurance has become a “must-to-have” necessity to every Consumer to secure themselves and their families against losses caused due to illness, global pandemics, accidents, and damage caused due to natural disasters. Therefore, an average Consumer carries a minimum of 2-3 insurance policies through multiple carriers to support his/her daily lifestyle, which is still not sufficient to cover all types of risk.

Consumers struggle with multiple carriers to cover all their insurance needs. Today's insurance consumer experience involves paperwork, phone calls, and manual online searches. The interaction model between the Consumers and their insurance providers has been limited i.e., it's more prominent at the point of sale and then when renewal or a claim activity occurs, the period post-policy issuance and the policy renewal or claim filing is quiet where minimal to no communication occurs between the insurance provider, its liaison such as the agent, and the insured “Consumer” or “its customer”. Worldwide in the product categories of home, auto, life, and health insurance, most customers purchase an insurance product only every three to six years. In developed markets, just half of the customers have had any contact with their insurers for any reason in the past 12 months.

Due to the technological and digital revolution, consumers are integrating IoT devices as part of their everyday lifestyle. Today, the majority of the consumers carry smartphones and have also integrated devices like a Fitbit to continually track their activity data. As consumers continue to integrate digital experiences into their everyday lives, they expect these experiences, as well as their relationship with insurers, to become more direct, simple, and intuitive. Consumers are expressing strong interest in seeing insurers develop innovative products that apply technology-driven capabilities and are deployed close to the source of their needs. New “digital native” insurers are well positioned to address these consumer expectations and can operate much more efficiently, they present a significant threat to incumbents.

Consumers want to know that their personal assets are insured and covered from any external factors such as natural disasters, robberies, or losing/miss placing assets. Consumers want to be able to file claims, receive payments on insured items seamlessly without having a lot of touchpoints and without feeling they are making false claims. Insurers have long struggled to attract and retain customers. They do business in a highly competitive marketplace, and they sell a product that many consumers consider a commodity. There are a number of insurance companies “insurers” who are specialized in providing specific insurance products such as travel insurance, health insurance, etc. while some provide multi-dimensional products related to their daily lifestyle such as auto, home, etc.

There is no single carrier that provides all types of insurance products to a consumer. These insurance providers use different channels to reach out to the masses-they market and sell their products through their digital portals, brokerage firms, field agents, etc. They make a significant spend on these channels to attract consumers but they still struggle to retain them due to the rising competition, user experience, pricing, etc. Insurance companies traditionally have never been at the forefront of innovation to date, however, with the new millennial population and rising regulatory pressure, it has become a priority for the insurance companies. The Tier-1 insurers are well positioned to make investments to change their customer experience model, however, the Tier-2 insurers will struggle to prioritize modernizing their customer interaction model over modernizing their policy and claims management application.

Therefore, there is a need for improved methods, systems, apparatuses, and devices for facilitating managing insurances for individuals that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method and system for facilitating insurance management for individuals. The method includes receiving, via a communication device, individual information from one or more individual devices associated with an individual, including health monitoring devices configured to generate health information based on monitored health metrics.

The individual information is analyzed using one or more machine learning models configured to assess risks associated with the individual's assets and person. A risk profile is generated reflecting exposure to identified risks. Based on the risk profile, one or more insurance requirements are determined, and one or more insurance providers and insurance brokers are identified that provide insurance products addressing the determined requirements.

Communication links are established between the individual devices and the identified insurance provider and broker devices, enabling interaction between the individual and the insurance providers and brokers. Upon receiving insurance operation indications from the individual device, one or more insurance operations are performed, and corresponding insurance documents are generated and stored along with the individual information.

The disclosed system includes a communication device configured to receive individual information and insurance operation indications from one or more individual devices; a processing device configured to analyze the individual information using machine learning models, generate a risk profile, determine insurance requirements, identify insurance providers and brokers, establish communication links, perform insurance operations, and generate insurance documents; and a storage device configured to store the insurance documents and individual information.

The foregoing summary and detailed description provide examples and are explanatory only. Accordingly, the foregoing summary and detailed description are not restrictive. Features or variations may be provided in addition to those set forth herein. Embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a flowchart of a method for facilitating management of insurance for individuals, in accordance with some embodiments.

FIG. 3 is a block diagram depicting a system architecture overview for the insurance management platform, showing interactions between major system components and data flows, in accordance with some embodiments.

FIG. 4 is a detailed block diagram of a document ingestion pipeline illustrating an artificial intelligence extraction process for automated data extraction from insurance documents, in accordance with some embodiments.

FIG. 5 is a flow diagram illustrating risk profiling and claims orchestration processes, including risk assessment engines and claims packet assembly mechanisms, in accordance with some embodiments.

FIG. 6 is a block diagram illustrating an asset vault process flow for secure storage and management of user digital assets and documents, in accordance with some embodiments.

FIG. 7 is a flow diagram illustrating a quote comparison module and conversational artificial intelligence interface for personalized insurance recommendations, in accordance with some embodiments.

FIG. 8 is a block diagram depicting a canonical policy schema with field-level confidence scores and versioned snapshots with lineage metadata, in accordance with some embodiments.

FIG. 9 is a block diagram illustrating an artificial intelligence extraction pipeline with sequential processing stages including template detection, segmentation, language model constrained decoding, bounded error reconciliation, and human-in-the-loop review, in accordance with some embodiments.

FIG. 10 is a block diagram depicting a federated learning data management module with privacy-preserving mechanisms and model aggregation processes, in accordance with some embodiments.

FIG. 11 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods.

Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for facilitating managing insurances for individuals, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet.

In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network.

Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices.

The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel.

Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on. Further, in some embodiments, the storage device may be configured for providing immutable and decentralized storage of the data using a distributed ledger. Further, the distributed ledger may be used to collect, store, timestamp, and process the data in a secure, tamper-proof, and distributed way.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or or possession of one or more embodied characteristics unique to the user (e.g. biometric variables such as but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.).

Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps. Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device.

Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer.

Accordingly, one or more steps of the method operating on the sensitive data and/or a derivative thereof may be performed at the client device.

### Overview

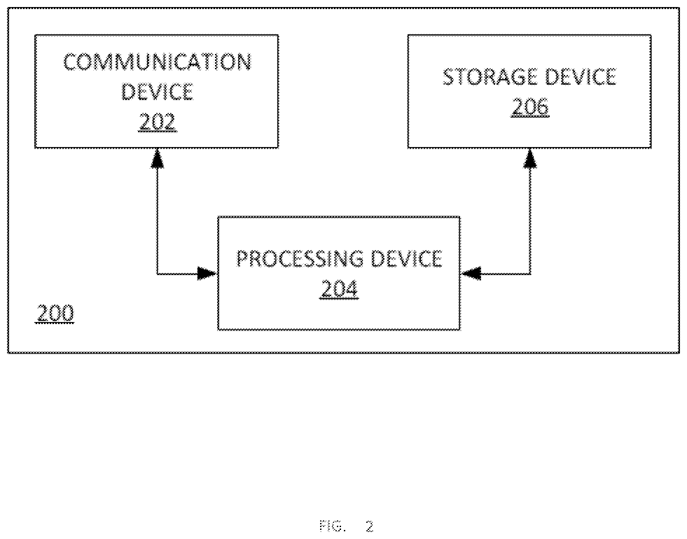

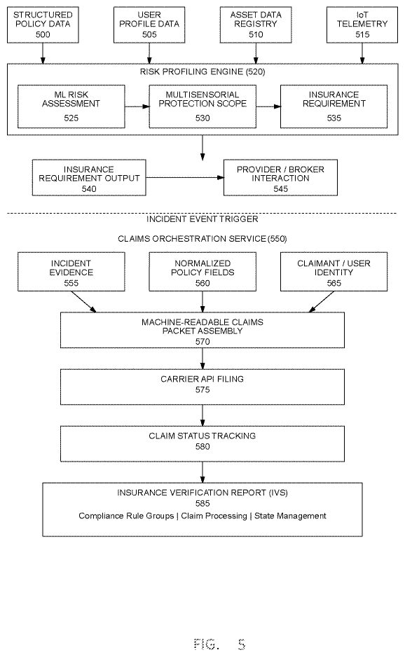

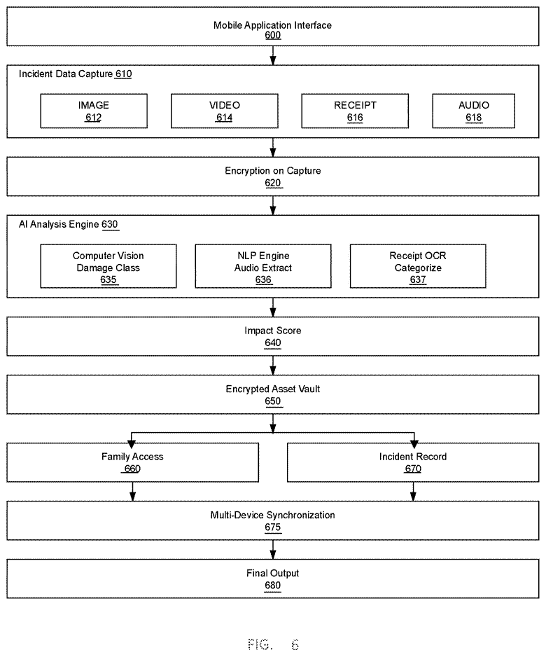

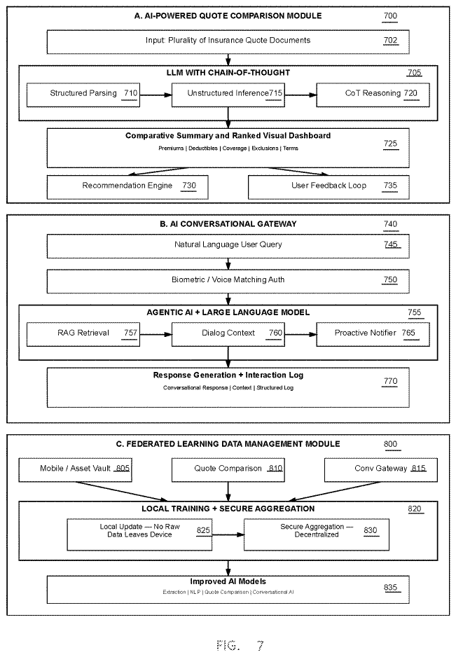

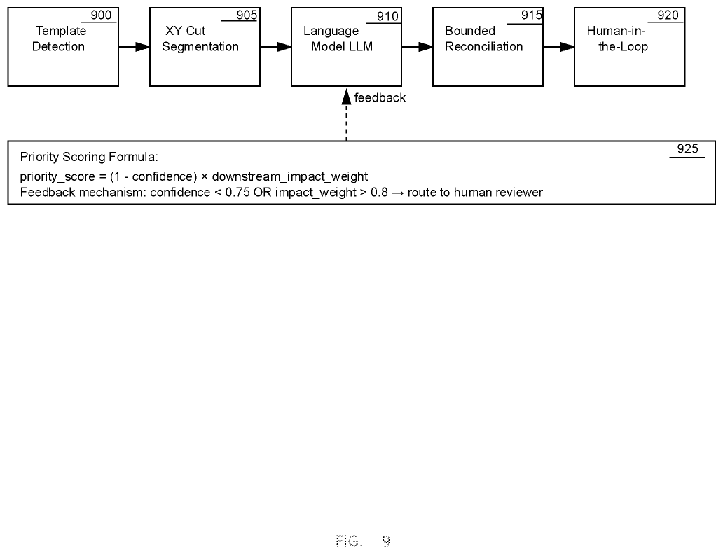

The present invention, as illustrated in FIG. 2, provides a system and method comprising a communication device (element 202), a processing device (element 204), a storage device (element 206), an artificial intelligence extraction pipeline (elements 900-925, FIG. 9), a risk profiling engine (element 520, FIG. 5), a claims orchestration service (element 550, FIG. 5), an asset vault subsystem (element 600, FIG. 6), an AI-powered quote comparison module (element 700, FIG. 7), an AI conversational gateway (element 740, FIG. 7), and a federated learning data management module (element 800, FIG. 7), wherein each component operates in coordinated fashion to facilitate insurance verification, document processing, asset management, quote comparison, and claims orchestration for individuals and households.

### Communication Device and Individual Information Reception

As shown in FIG. 2, the communication device is element 202, configured to receive individual information from at least one individual device associated with an individual. The individual information includes health information obtained from a health monitoring device worn by the individual. The communication device 202 receives insurance operation indications representing system state changes and trigger events emanating from external sources. The communication device 202 further receives Internet-of-Things telemetry including smart home sensor events and telematics data, establishing the foundation for risk assessment and downstream processing by the processing device 204.

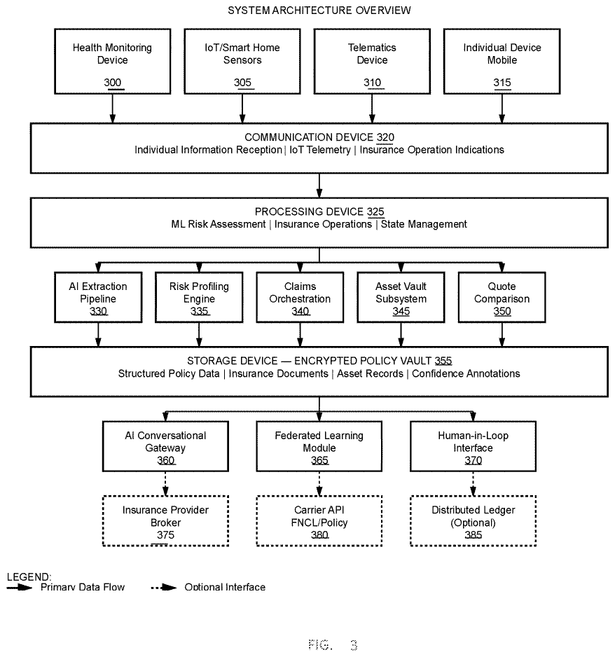

As illustrated in FIG. 2 and FIG. 3, the communication device element 202 receives individual information from multiple input sources including health monitoring devices, IoT/smart home sensors, telematics devices, and individual mobile devices. The communication device 202 captures individual information reception, IoT telemetry, and insurance operation indications from these diverse sources.

The processing device element 204 analyzes the received individual information using at least one machine learning model to assess risk associated with at least one of an asset of the individual or the individual themselves. The machine learning model generates a risk profile indicating exposure to identified risks. Based on the risk profile, the processing device 204 determines at least one insurance requirement specifying coverage types and protection needs.

The processing device 204 further performs insurance operations in response to insurance operation indications received through the communication device 202, maintaining state management for ongoing interactions and transactions. The processing device 204 orchestrates five primary functional modules: the AI Extraction Pipeline element 330, Risk Profiling Engine element 335, Claims Orchestration Service element 340, Asset Vault Subsystem element 345, and Quote Comparison module element 350. All processed data is stored in the Storage Device element 206, which maintains the Encrypted Policy Vault containing structured policy data, insurance documents, asset records, and confidence annotations.

### Artificial Intelligence Extraction Pipeline

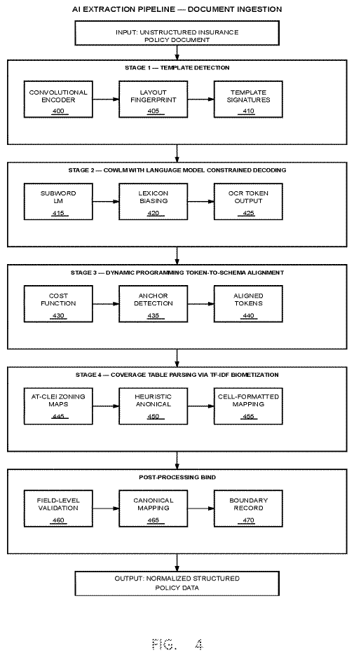

As shown in FIG. 4 and FIG. 9, the processing device 204 executes a defined document ingestion pipeline that transforms unstructured insurance policy documents into normalized structured policy data. The defined document ingestion pipeline comprises five primary algorithmic stages: template detection element 900, XY cut segmentation element 905, optical character recognition with language model constrained decoding element 910, dynamic programming token-to-schema alignment element 915, and human-in-the-loop review element 920, with priority scoring element 925 using feedback mechanisms for continuous refinement.

### Template Detection Stage

As depicted in FIG. 9, the processing device performs template detection using a supervised classifier trained to identify document layout patterns and insurer-specific formatting. The supervised classifier employs learned layout features including logo embeddings and layout fingerprints.

In one embodiment, the supervised classifier comprises a convolutional encoder that produces logo embeddings, which are concatenated with a layout fingerprint vector to form a template signature. The template detection stage 900 identifies the insurer, policy type, and document format variant, enabling downstream components to apply insurer-specific processing rules.

### Optical Character Recognition With Language Model Constrained Decoding

As shown in FIG. 9 element 910, the processing device performs optical character recognition with language model constrained decoding biased to insurance lexicons. The OCR component uses subword language models for constrained decoding with a configurable beam width to balance accuracy and latency. The language model constrained decoding 910 comprises beam search with a domain language model trained on insurer corpora and lexicon biasing of coverage terms, carrier names, and policy artifacts. This approach improves accuracy beyond baseline OCR performance by leveraging domain-specific terminology and expected token sequences common in insurance documents.

Dynamic Programming Token-to-schema Alignment

As illustrated in FIG. 9 element 915, the processing device aligns OCR tokens to schema fields via a dynamic programming cost function combining edit distance, spatial proximity, and language model likelihood. The dynamic programming token alignment 915 employs anchor detection for field labels and enforces adjacency constraints to reduce cross-field swaps, ensuring that extracted tokens maintain their logical relationship to expected schema fields. The cost function incorporates three distance metrics that are computationally combined to determine optimal token-to-field mappings while respecting document structure and reading order.

### Coverage Table Parsing via XY Cut Segmentation

As shown in FIG. 9, the processing device detects table templates (element 900) and then parses coverage tables using XY cut segmentation (element 905) with header normalization. XY cut segmentation applies recursive partitioning until region entropy or minimum text density thresholds are met and confirms table regions via column alignment scoring. Following table region detection, the processing device applies header canonicalization that maps synonymous headers to a controlled vocabulary. Header canonicalization includes at least mappings for “BI,” “PD,” “UM,” “UIM,” “Comp. ,” “Collision,” and “Ded.” Cells are mapped to headers using geometric alignment with fallback to header proximity when geometric alignment is ambiguous.

### Field-Level Confidence Computation

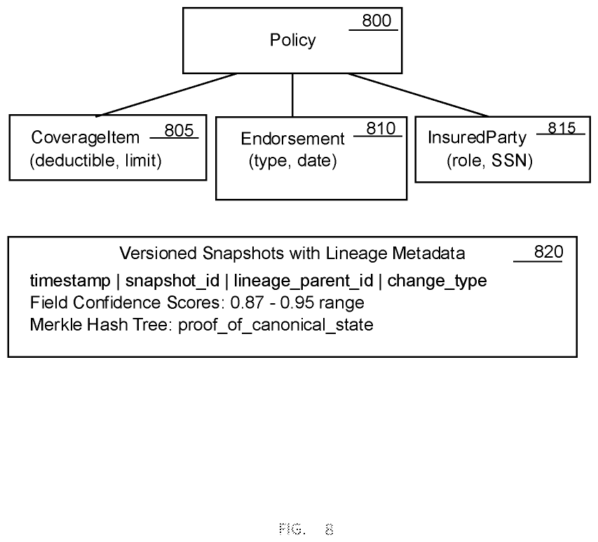

As depicted in FIG. 8, the processing device computes field-level confidence scores from token posteriors and schema constraint satisfiability. These confidence scores are stored with versioned snapshots and lineage metadata (element 820). Field-level confidence incorporates structural conformity checks comprising regex validation for policy numbers, chronological ordering of effective and expiry dates, and currency and unit normalization for limits and deductibles. The field-level confidence quantifies the estimated accuracy of each extracted value. As shown in FIG. 9, element 925 (Priority Scoring Formula) uses these confidence scores to enable downstream components to prioritize fields for human review or apply automated processing with reduced risk of error.

### Canonical Policy Schema and Normalization

As illustrated in FIG. 8, the processing device normalizes extracted values into a canonical policy schema with defined field constraints and relationships. The canonical policy schema (element 800) defines field domains, cardinalities, and foreign key relationships among CoverageItem (element 805), Endorsement (element 810), and InsuredParty (element 815) entities. The schema maintains versioned snapshots with lineage metadata (element 820). The canonical policy schema is stored with field-level confidence annotations and lineage metadata linking each field value to a source segment and extraction method. This structured representation enables consistent processing across heterogeneous insurer documents and facilitates downstream risk assessment and claims operations.

### Bounded Error Reconciliation Routine

The processing device applies a bounded error reconciliation routine that resolves conflicts between free text and table extractions using deterministic precedence rules. The bounded error reconciliation routine selects table-extracted values over free-text values when confidence separation exceeds a threshold and unit consistency is satisfied, and otherwise marks the field for human review. Confidence separation represents the difference in confidence scores between conflicting extraction sources, enabling deterministic resolution of ambiguities based on source reliability.

### Storage Device and Encrypted Policy Vault

The storage device is configured to store insurance documents and structured policy data in an encrypted policy vault (FIG. 3, element 355). The processing device receives, from at least one individual device, an individual encryption key and encrypts the structured policy data and insurance documents using the individual encryption key. Encrypted artifacts are stored in the policy vault 355, with optional storage of hash commitments on a distributed ledger for tamper evidence.

In some embodiments, the processing device generates a Merkle root over packet sections and optionally anchors the root on a distributed ledger, with inclusion proofs transmitted to a carrier API as shown in FIG. 5, element 575.

### Risk Profiling Engine and Multidimensional Scoring

As illustrated in FIG. 5, the processing device computes, through a risk profiling engine (element 520), a multidimensional protection score using normalized policy data (element 500), user profile data (element 505), assets (element 510), and telemetry information (element 515). The multidimensional protection score is computed based on the structured policy data, user profile, asset data, and Internet-of-Things telemetry including at least one of smart home sensor events or telematics data.

In some embodiments, the multidimensional score integrates policy presence across mandatory and optional insurance categories, coverage depth relative to cluster-ideal benchmarks, and technology adoption indicators derived from connected device signals.

### Claims Orchestration Service

As shown in FIG. 5, the Claims Orchestration Service element 550 orchestrates first notice of loss claim filing via carrier application programming interfaces with status tracking, secure messaging, and optional immutable audit logs via a distributed ledger. The Claims Orchestration Service 550 integrates three primary components: Incident Evidence element 555, Normalized Policy Fields element 560, and Claimant/User Identity element 565.

The Claims Orchestration Service 550 assembles a machine-readable claims packet element 570 for first notice of loss using the normalized policy fields 560 and incident evidence 555. The machine-readable claims packet 570 is filed via the Carrier API Filing element 575, enabling integration with insurance carrier backend systems. The Carrier API Filing 575 integrates with Claim Status Tracking element 580 to maintain status updates and optional immutable audit logs wherein selected claims packets are recorded on a distributed ledger for tamper evidence and auditability. The Insurance Verification Report element 585 provides compliance rule groups, claim processing verification, and state management oversight of the filed claims.

### Asset Vault Subsystem and Mobile Interface

As illustrated in FIG. 6, the system comprises a mobile interface element 600 configured to implement an asset vault process flow. The mobile interface element 600 enables an individual to document incident-related information associated with an asset by capturing image, video, receipt, and audio data through the Incident Data Capture module element 610, which includes IMAGE 612, VIDEO 614, RECEIPT 616, and AUDIO 618 sub-components. The mobile application provides guided user prompts for real-time verbal descriptions during incident documentation.

The Incident Data Capture module 610 feeds into the Encryption on Capture module element 620, which encrypts the captured image, video, receipt, and audio data upon capture. The encrypted data is stored in the Encrypted Asset Vault element 650 and synchronized across authenticated devices associated with authorized users. The receipt analysis functionality is performed through the Receipt OCR Categorize component element 637 within the AI Analysis Engine 630, which categorizes recorded receipts, automatically associates receipts with corresponding incidents or assets, and extracts monetary values, item descriptions, and transaction dates.

The system comprises an AI Analysis Engine element 630 in FIG. 6 configured to integrate computer vision (element 635), natural language processing (element 636), and structured receipt optical character recognition (element 637) models to assess damage and categorize documented incidents. The AI Analysis Engine 630 processes encrypted image data from IMAGE 612, video data from VIDEO 614, and receipt data from RECEIPT 616 to determine damage classification, incident category, and estimated cost of damage by applying multimodal deep learning analysis.

The AI Analysis Engine 630 processes, through the NLP Engine Audio Extract component element 636, audio descriptions associated with incident documentation to extract structured incident information. The AI Analysis Engine 630 calculates an Impact Score element 640 representative of the severity of the incident and generates, based on the impact score, automated recommendations for claims initiation or asset protection measures.

The Encrypted Asset Vault 650 works in conjunction with the Family Access feature element 660 in FIG. 6, which allows one or more verified family members to view selected assets through authenticated shared access governed by role-based permissions. The processing device maintains an immutable record of user and family interactions within the asset vault, wherein each record includes a time-stamped event log protected using cryptographic hashing and, optionally, blockchain anchoring for tamper evidence.

The processing device cross-references data stored in the Encrypted Asset Vault 650 with structured policy data and claims data to generate unified incident records and enable integrated retrieval and reporting. The mobile interface is further configured to synchronize encrypted vault data across multiple authenticated family member accounts through the Multi-Device Synchronization element 675.

The mobile application implements encryption operations using individual encryption keys associated with each user. Individual encryption keys may be stored locally on the individual device or retrieved from secure key management infrastructure. The mobile application applies symmetric encryption with AES-256 cipher to image data from IMAGE 612, video data from VIDEO 614, and receipt data from RECEIPT 616 prior to storage in the Encrypted Asset Vault element 650. Encrypted artifacts are stored in the secure vault 650 implemented as an encrypted database or secure enclave on the individual device.

The mobile application is further configured to synchronize encrypted vault data across multiple authenticated devices associated with the individual and authorized family members through the Multi-Device Synchronization module element 675. Synchronization may occur via secure peer-to-peer protocols or cloud-based infrastructure implementing end-to-end encryption where the processing device retains no access to unencrypted data. Synchronization operations include conflict resolution logic to maintain consistency across devices when the same asset is documented from multiple devices. Version control metadata tracks the timestamp, device identifier, and user identifier for each vault entry via the Incident Record element 670, enabling audit trails of modification history.

The receipt analysis is performed through the Receipt OCR Categorize component element 637 within the AI Analysis Engine 630, which processes captured receipt data through OCR and structured parsing. The Receipt OCR Categorize module 637 categorizes captured receipts by type including purchase receipts, repair invoices, warranty documents, or maintenance records. The Receipt OCR Categorize module 637 automatically associates receipts with corresponding assets and extracts monetary values, item descriptions, and transaction dates from receipt text.

The Family Access feature element 660 allows verified family members to view selected asset documentation through authenticated shared access. Access to shared asset documentation is governed by role-based permissions that restrict viewing to designated family members and maintain an immutable audit log of all access events. The immutable audit log records the identity of the accessing user, the asset or incident accessed, the timestamp of access, and the duration of access. The audit log is protected using cryptographic hashing and optionally anchored on a distributed ledger to provide tamper evidence. The processing device maintains a complete record of all user interactions through the Incident Record element 670, including creation of new asset records, modification of asset documentation, sharing of asset access with family members, and retrieval of asset information for claims or verification purposes, enabling audit trails of modification history.

The Final Output element 680 integrates results from all processing stages, enabling comprehensive incident documentation, damage assessment, and asset protection workflows supported by the complete asset vault infrastructure.

### Multimodal Deep Learning Analysis

The AI analysis engine element 630 implements multimodal deep learning analysis combining computer vision models element 635, natural language processing models element 636, and structured data parsers element 637. The computer vision component element 635 processes image data through a convolutional neural network trained to detect damage patterns, assess damage severity, and classify damage types including fire damage, water damage, structural damage, theft-related damage, or natural disaster damage. The computer vision component element 635 generates damage classification outputs with confidence scores and bounding box annotations indicating damage regions within images, which are processed through the impact score calculation element 640.

The AI analysis engine element 630 processes video data by extracting keyframes at regular temporal intervals and applying computer vision analysis element 635 to each keyframe. Temporal analysis identifies damage progression patterns and severity trends across the video sequence. Audio analysis element 636 extracts spoken descriptions from video audio tracks and processes natural language content for incident information extraction.

### Natural Language Processing for Incident Extraction

The AI analysis engine element 630 comprises a natural language processing engine element 636 configured to process audio descriptions associated with incident documentation. Users provide verbal descriptions during incident documentation, which the mobile application records as audio data alongside captured image and video data. The NLP engine element 636 transcribes audio data using automatic speech recognition and extracts structured incident information including incident date, location, incident type, involved parties, and damage description. The NLP engine element 636 applies named entity recognition to identify locations, asset types, and party identifiers. The NLP engine element 636 applies relationship extraction to identify causal relationships between incident events and damage outcomes. The NLP engine element 636 generates structured incident information with extracted fields and confidence scores for each extracted entity and relationship, which flows to the impact score element 640 and is stored in the incident record element 670.

### Receipt Analysis and Expense Calculation

The AI analysis engine element 630 comprises a receipt capture function that processes captured receipt data through optical character recognition (OCR) and structured parsing. The receipt OCR categorize module element 637, a sub-component of the AI analysis engine, categorizes captured receipts by type including purchase receipts, repair invoices, warranty documents, or maintenance records. The receipt OCR categorize module element 637 automatically associates receipts with corresponding assets based on asset identifiers extracted from receipt text or user-provided associations. The receipt OCR categorize module element 637 extracts monetary values, item descriptions, and transaction dates from receipt text. The AI analysis engine element 630 aggregates receipt values by asset, by incident, and by time period, storing this expense data within the incident record element 670, enabling expense reporting and asset value tracking.

### Impact Scoring and Severity Assessment

The AI analysis engine element 630 calculates an impact score element 640 representative of the severity of the incident based on multiple factors including damage extent detected in images and video, damage type classification from computer vision analysis element 635, incident type from NLP extraction element 636, and estimated cost from receipt data analysis element 637. The impact score element 640 combines normalized subscores for damage severity, asset value, replacement cost, and repair cost using a weighted aggregation function. The impact score element 640 ranges from 0 to 100, with higher scores indicating greater incident severity.

The AI analysis engine element 630 generates, based on the impact score element 640, automated recommendations for claims initiation, asset protection measures, or preventive actions. Recommendations with impact scores exceeding a configured severity threshold trigger automatic notification to the individual and optional claims initiation prompts. Recommendations may include suggestions to file an insurance claim, contact repair services, or implement protective measures to prevent future incidents. Each recommendation includes an explanation of the recommendation rationale based on the detected damage classification, estimated cost, and policy coverage analysis.

### Model Confidence and Human Review

The AI analysis engine element 630 provides confidence scores for each damage classification, incident category, and cost estimation. Fields or recommendations with confidence scores below a configured threshold are surfaced for human review through a dedicated user interface within the mobile application element 600. User edits and corrections to AI-generated classifications are captured as labeled training examples and fed back to the AI analysis engine element 630 for continuous improvement of damage detection and incident categorization models performed by the computer vision damage class element 635, NLP engine audio extract element 636, and receipt OCR categorize element 637.

### Quote Comparison Module

As shown in FIG. 7, the system further comprises an AI-powered quote comparison module 700 configured to analyze, through a large language model trained with chain-of-thought prompting, a plurality of insurance quote documents to extract and evaluate insurance policy attributes.

The AI-powered quote comparison module 700 receives input from a plurality of insurance quote documents (element 702) and processes them through a chain-of-thought enabled large language model (element 705) that performs structured parsing (element 710), unstructured inference (element 715), and chain-of-thought reasoning (element 720) to extract policy parameters including policy tenure, premium cost, coverage limits, deductible values, exclusions, and special clauses using both structured data parsing and unstructured text inference.

The large language model performs chain-of-thought reasoning to infer relationships between extracted parameters and to enhance interpretability and accuracy of extracted insurance attributes. The processing device generates a comparative summary and ranked visual dashboard (element 725) in FIG. 7 that presents key differences and similarities in premiums, deductibles, coverage, exclusions, and policy terms among the analyzed insurance quotes. The user interface displays the comparative summary 725 in a ranked visual layout that highlights policy strengths and weaknesses relative to user preferences.

The AI-powered quote comparison module 700 further comprises a recommendation engine (element 730) that determines one or more recommended insurance options based on user-defined preferences and policy selection goals, wherein each recommendation includes an explainable rationale derived from the chain-of-thought reasoning. A user feedback loop (element 735) enables users to provide satisfaction or dissatisfaction feedback with the provided recommendations. The large language model updates one or more trained parameters based on this user feedback, thereby improving future personalization accuracy.

The CoT-prompted large language model quote comparison module 700 is further configured to display comparative results through the graphical dashboard (element 725) highlighting differences in premium amounts, deductible levels, and coverage limits.

### Conversational Artificial Intelligence Gateway

As illustrated in FIG. 7, the system further comprises an AI conversational gateway 740 employing agentic AI 755 configured to enable a user to retrieve and query insurance policy information, identification documents, or asset information using natural language input. The natural language user query 745 is processed through biometric or voice matching authentication 750 to ensure secure access. The agentic AI 755 retrieves, from a policy and document repository, information relevant to a received user query using RAG retrieval 757 and generates, using a large language model with dialog context 760, concise and contextually appropriate responses for display within the response generation and interaction log element 770.

The dialog context 760 maintains conversation context across multiple user turns to support iterative, multi-step interactions and follow-up questions. The processing device secures all conversational interactions through end-to-end encryption and user authentication implemented via biometric verification or voice matching 750. The agentic AI 755 generates proactive notifications 765 and recommendations to the user regarding insurance policy expiration, coverage adequacy, or potential policy adjustments based on the user profile and telemetry data.

The processing device stores a structured log of user interactions in element 770, wherein each log entry is converted into a training instance for continuous improvement of the dialog context 760 in relation to intent recognition and contextual accuracy. The AI conversational gateway 740 maintains persistent conversational context and dynamically generates responses based on information verified from structured policy data and document repositories.

### Federated Learning Data Management Module

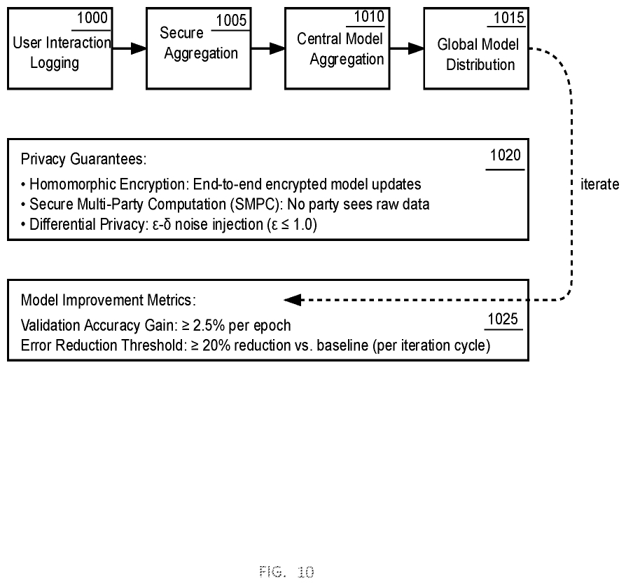

As shown in FIG. 10, the federated learning pipeline orchestrates the aggregation of locally-trained models from distributed devices through a series of coordinated processing steps. The pipeline receives user interactions logged by element 1000 and processes them through secure aggregation protocols implemented by element 1005. Central model aggregation is performed by element 1010 to ensure that no raw user data is transmitted beyond local devices during distributed training.

The central model aggregation process (element 1010) employs privacy-preserving techniques including homomorphic encryption, secure multi-party computation (SMPC), and differential privacy as detailed in element 1020, before distributing the improved global model through element 1015.

In some embodiments, the federated learning pipeline aggregates model updates and converts them into improved training instances that enhance underlying machine learning models while maintaining user privacy through the mechanisms identified in element 1020. The system monitors model improvement metrics as shown in element 1025.

The federated learning data management module (element 800, as shown in FIG. 7) orchestrates this entire pipeline to capture user interactions across all components and support continuous improvement of underlying machine learning models.

### System Integration and Data Flow

As depicted in FIG. 2, the system comprises three primary hardware components: a communication device (element 202) that interfaces with users and external systems, a processing device (element 204) that executes machine learning models and orchestrates workflows, and a storage device (element 206) that maintains encrypted policy data and asset information.

Individual information flows from the communication device (element 202) to the processing device (element 204), where it is analyzed by machine learning models to generate risk profiles and insurance requirements. Insurance documents are ingested through the AI extraction pipeline shown in FIG. 4, transforming unstructured policy documents into normalized structured data stored in the storage device (element 206).

The risk profiling engine (element 520, FIG. 5) computes multidimensional insurance requirement scores using normalized policy data (element 500) combined with user profile (element 505) and telemetry information (element 515). When claims occur, the claims orchestration service (element 550, FIG. 5) assembles claims packets using normalized policy fields and asset vault evidence, and files them via carrier APIs.

The mobile application interface (element 600, FIG. 6) enables individuals to document personal assets and incident-related information, with automated AI analysis of damage and incident categorization. The AI-powered quote comparison module (element 700, FIG. 7) enables analysis and comparison of insurance quotes through LLM-based extraction and reasoning. The AI conversational gateway (element 740, FIG. 7) enables natural-language queries over policy and asset information, with biometric/voice matching authentication (element 750, FIG. 7) for secure access.

The federated learning data management module (element 800, FIG. 7) captures user interactions across all components to support continuous improvement of underlying machine learning models while preserving privacy through secure aggregation and privacy-preserving techniques (element 1000, FIG. 10, User Interaction Logging feeds into the federated learning pipeline).

Human-in-the-loop Interface and Continuous Learning

The processing device provides a human-in-the-loop interface that prioritizes low-confidence fields for correction and continuous model improvement. Fields with confidence below a threshold τ are selectively surfaced to human reviewers.

User edits captured in the human-in-the-loop interface are stored as labeled examples for continuous training of extraction models. The human-in-the-loop interface is shown as element 920 in FIG. 9 and is configured to prioritize fields by an expected error reduction score computed based on field confidence and downstream impact on claims or recommendations. Model improvement metrics (element 1025 in FIG. 10) track validation accuracy gains and error-reduction thresholds resulting from these human corrections.

### Extraction Pipeline Performance

The defined document ingestion pipeline FIG. 9, as described above, reduces field extraction error by at least twenty percent and reduces end-to-end ingestion latency by at least fifteen percent relative to a baseline OCR and pattern matching approach across heterogeneous insurer templates.

### Platform Overview

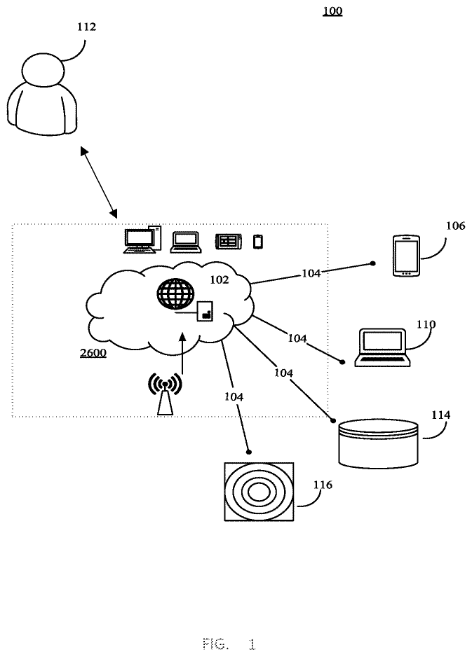

As illustrated in FIG. 1, the online platform provides a comprehensive user interface for insurance management. The platform integrates all system components through coordinated workflows accessible via web browsers and mobile applications.

### Computing Device Architecture

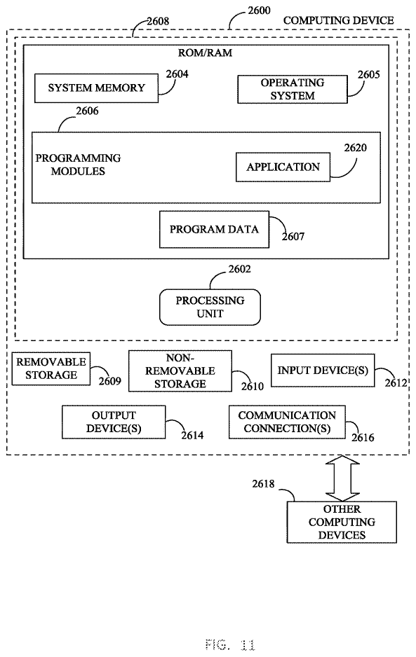

As shown in FIG. 11, the computing device comprises processor and memory elements for implementing the methods disclosed herein, in accordance with some embodiments.

### Deployment Embodiments

In one embodiment, the system is deployed as a cloud-native platform accessible via web browsers and mobile applications. In another embodiment, the system is deployed on-premises within an individual insurer's or broker's infrastructure.

In some embodiments, the distributed ledger comprises a permissioned blockchain. In other embodiments, the distributed ledger is omitted, and immutable records are maintained through cryptographic hashing and secure storage.

In preferred embodiments, the processing device implements machine learning models using state-of-the-art architectures including convolutional neural networks for XY cut segmentation (element 905, FIG. 9), transformers for language modeling (element 910, FIG. 9), and gradient-boosted decision trees for risk assessment.

In some embodiments, the human-in-the-loop interface surfaces fields below a confidence threshold τ for correction, as detailed in element 920 (FIG. 9).

As shown in FIG. 10, the federated learning pipeline orchestrates the training process by receiving user interactions logged by element 1000, processing them through secure aggregation protocols implemented by element 1005, aggregating model updates centrally via element 1010, and implementing privacy-preserving techniques as described in element 1020 (including homomorphic encryption, secure multi-party computation, and differential privacy) to ensure that no raw user data is transmitted beyond local devices during distributed training. The improved global model is subsequently distributed through element 1015, with model improvement metrics tracked as shown in element 1025.

### Interaction Logging and Data Structuring

User interactions across the mobile asset vault, quote comparison module, and conversational gateway are captured and logged at element 1000 (User Interaction Logging). These logs include timestamps, user/device identifiers, interaction types (asset modifications, quote submissions, conversation queries), and associated data elements.

The interaction data flows through the federated learning pipeline: element 1005 (Secure Aggregation) encrypts the data at the device level, element 1010 (Central Model Aggregation) combines the encrypted model updates from multiple devices, and element 1015 (Global Model Distribution) returns the improved global model to each device. Throughout this pipeline, element 1020 (Privacy Guarantees) enforces differential privacy and secure computation to protect individual user data. Element 1025 (Model Improvement Metrics) tracks performance improvements from this federated training process.

### Training Data Curation and Labeling

User interactions across the mobile asset vault, quote comparison module, and conversational gateway are captured and logged at element 1000 (User Interaction Logging). These logs include timestamps, user/device identifiers, interaction types (asset modifications, quote submissions, conversation queries), and associated data elements.

The interaction data flows through the federated learning pipeline: element 1005 (Secure Aggregation) encrypts the data at the device level, element 1010 (Central Model Aggregation) combines the encrypted model updates from multiple devices, and element 1015 (Global Model Distribution) returns the improved global model to each device. Throughout this pipeline, element 1020 (Privacy Guarantees) enforces differential privacy and secure computation to protect individual user data. Element 1025 (Model Improvement Metrics) tracks performance improvements from this federated training process.

### Privacy-preserving Federated Learning

The federated learning pipeline implements privacy-preserving model updates through secure aggregation (element 1005) and federated learning architectures. Local model training occurs on individual devices using each user's interaction logs and captured data without transmitting raw user data to the central server.

Periodic synchronization occurs wherein local model updates from individual devices are aggregated using secure aggregation protocols (element 1005), combining model parameter updates from multiple devices through cryptographic methods ensuring that no individual device's model updates are revealed during aggregation. The aggregation process applies differential privacy techniques (element 1020) adding calibrated noise to aggregated parameters to further protect individual privacy.

The central model aggregation (element 1010) combines the encrypted model updates across all participating devices. Version tracking and integrity validation ensure that each aggregated model is tagged with version identifier, update timestamp, count of participating devices, and cryptographic validation of aggregated parameters.

All update operations are logged with immutable records protected through cryptographic integrity verification. The improved global model is subsequently distributed (element 1015) back to participating devices in the federated network, enabling continuous model improvement while maintaining individual privacy throughout the process.

### Model Improvement Feedback Loop

The federated learning data management module feeds curated training instances back to respective AI models for continuous improvement. Computer vision damage classification models are retrained using curated training instances with user-confirmed damage classifications, enabling improved accuracy on previously misclassified damage types. NLP incident extraction models are retrained using curated training instances with user-corrected incident information, improving entity recognition and relationship extraction accuracy.

LLM quote comparison models incorporate curated training instances reflecting user preference patterns and policy selection criteria, improving the personalization and relevance of recommendations. Conversational gateway models incorporate training instances reflecting successful query resolution patterns and user satisfaction metrics, improving intent recognition accuracy and response appropriateness.

The federated learning data management module implements active learning strategies to identify high-value training instances for labeling. Interaction logs generating low-confidence outputs or outputs rejected by users are prioritized for inclusion in training instances, focusing model improvement on the most challenging and impactful cases.

### Audit Trails and Tamper Evidence

The federated learning data management module element 800 maintains immutable audit trails of all data collection, processing, and model update operations. Each audit trail entry includes timestamp, operation identifier, user or system identifier performing the operation, data elements involved, processing steps executed, and result outputs. Audit trail entries are protected using cryptographic hashing linking each entry to the previous entry in a hash chain, ensuring tamper detection if any entry is modified.

The federated learning data management module element 800 optionally anchors audit trail records on a distributed ledger implementing blockchain technology. Periodic snapshots of audit trail data are hashed and committed to the distributed ledger, creating immutable records of federated learning operations with timestamp proofs and inclusion proofs verifiable against the public ledger.

In other embodiments, the threshold τ is adjusted dynamically based on downstream impact assessment.

In preferred embodiments, the template detection 900, FIG. 9 employs multi-task neural network learning that jointly trains to predict insurer identity, document type, and policy line of business.

The defined document ingestion pipeline described herein, comprising template detection, language model constrained decoding, dynamic programming token alignment, XY cut table parsing, field-level confidence computation, canonical schema normalization, bounded error reconciliation, and human-in-the-loop continuous learning, represents a comprehensive system for transforming heterogeneous insurance documents into normalized structured data with measurable quality improvements relative to baseline approaches.

With reference to FIG. 11, a system consistent with an embodiment of the disclosure may include a computing device or cloud service, such as computing device 2600. In a basic configuration, computing device 2600 may include at least one processing unit 2602 and a system memory 2604. Depending on the configuration and type of computing device, system memory 2604 may comprise, but is not limited to, volatile (e.g. random-access memory (RAM)), non-volatile (e.g. read-only memory (ROM)), flash memory, or any combination. System memory 2604 may include operating system 2605, one or more programming modules 2606, and may include program data 2607. Operating system 2605, for example, may be suitable for controlling computing device 2600's operation. In one embodiment, programming modules 2606 may include an image-processing module and a machine learning module. Furthermore, embodiments of the disclosure may be practiced in conjunction with a graphics library, other operating systems, or any other application program and is not limited to any particular application or system. This basic configuration is illustrated in FIG. 11 by those components within a dashed line 2608.

Computing device 2600 may have additional features or functionality. For example, computing device 2600 may also include additional data storage devices (removable and/or non-removable) such as, for example, magnetic disks, optical disks, or tape. Such additional storage is illustrated in FIG. 11 by a removable storage 2609 and a non-removable storage 2610. Computer storage media may include volatile and non-volatile, removable and non-removable media implemented in any method or technology for storage of information, such as computer-readable instructions, data structures, program modules, or other data. System memory 2604, removable storage 2609, and non-removable storage 2610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2600. Any such computer storage media may be part of device 2600. Computing device 2600 may also have input device(s) 2612 such as a keyboard, a mouse, a pen, a sound input device, a touch input device, a location sensor, a camera, a biometric sensor, etc. Output device(s) 2614 such as a display, speakers, a printer, etc. may also be included. The aforementioned devices are examples and others may be used.

Computing device 2600 may also contain a communication connection 2616 that may allow device 2600 to communicate with other computing devices 2618, such as over a network in a distributed computing environment, for example, an intranet or the Internet. Communication connection 2616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2604, including operating system 2605. While executing on processing unit 2602, programming modules 2606 (e.g., application 2620 such as a media player) may perform processes including, for example, one or more stages of methods, algorithms, systems, applications, servers, databases as described above. The aforementioned process is an example, and processing unit 2602 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method comprising:
receiving, by a communication device, individual information from at least one individual device associated with an individual, the individual information including health information from a health monitoring device worn by the individual, and further receiving Internet-of-Things (IoT) telemetry including at least one of smart home sensor events or telematics data;
analyzing, by at least one machine learning model executing on a processing device, the individual information to assess risk associated with at least one of an asset of the individual or the individual, and generating a risk profile indicating exposure to the risk;
determining, by the processing device based on the risk profile, at least one insurance requirement and facilitating interaction between the individual and at least one of an insurance provider or an insurance broker via established communication links; and
generating and storing, by the processing device and a storage device, insurance documents and structured policy data in an encrypted policy vault,
wherein generating the structured policy data comprises executing, by the processing device, a defined document ingestion pipeline that:
performs template detection using a supervised classifier trained on learned layout features including logo embeddings and page layout signatures;
performs optical character recognition (OCR) with language model constrained decoding biased to insurance domain lexicons;
aligns OCR tokens to schema fields via a dynamic programming cost function combining edit distance between token text and schema field labels, spatial proximity between token positions and expected field regions, and language model likelihood scores;
parses coverage tables using XY cut segmentation with header normalization;
computes field-level confidence scores from token posteriors and structural conformity checks;
normalizes extracted values into a canonical policy schema with defined field constraints and relationships; and
stores the canonical policy schema with associated field-level confidence annotations and lineage metadata linking each field value to a corresponding source segment and extraction method;
applies a bounded error reconciliation routine that resolves conflicts between free-text and table extractions using deterministic precedence rules conditioned on confidence separation; and
surfaces, via a human-in-the-loop interface, fields with confidence scores below a threshold for human correction, wherein user corrections are stored as labeled examples for continuous model improvement;
wherein the defined document ingestion pipeline reduces field extraction error by at least 20% and reduces end-to-end ingestion latency by at least 15% relative to a baseline OCR and pattern matching approach across heterogeneous insurer templates; and further comprising:
computing, by a risk profiling engine executing on the processing device, a multidimensional score based on the structured policy data, a user profile, asset data, and the IoT telemetry; and
assembling, by a claims orchestration service executing on the processing device, a machine-readable claims packet for first notice of loss (FNOL) using normalized policy fields and incident evidence, and filing the claims packet via a carrier application programming interface (API).

2. The method of claim 1, wherein the supervised classifier comprises a multi-task neural network jointly trained to predict insurer identity, document type, and policy line of business, and jointly trained to learn logo embeddings from masthead crops and page layout signatures from visual layout features.

3. The method of claim 2, wherein the language model constrained decoding comprises beam search with a domain language model trained on insurer corpora and lexicon biasing of coverage terms, carrier names, and policy artifacts.

4. The method of claim 1, wherein aligning OCR tokens to schema fields comprises computing the dynamic programming cost function such that:
edit distance is computed between token text and a schema field label;
spatial distance is computed between a token position and an expected field region;
a language model likelihood score is computed for the token in the context of the schema field;
wherein the cost function enforces monotonicity in document reading order, applies penalties for alignments that cross document region boundaries, and the processing device selects, for each schema field, the token assignment that minimizes the cost function.

5. The method of claim 4, wherein parsing coverage tables further comprises:
detecting rectangular regions via XY cut guided by projection profiles, applying recursive partitioning until region entropy or minimum text density thresholds are met, and confirming table regions via column alignment scoring;
canonicalizing headers using a synonym dictionary and character-level similarity, wherein header canonicalization maps synonymous headers to a controlled vocabulary including at least mappings for “BI,” “PD,” “UM,” “UIM,” “Comp. ,” “Collision,” and “Ded.”; and
mapping cells to headers using geometric alignment with fallback to header proximity.

6. The method of claim 1, wherein computing field-level confidence scores comprises combining token posterior probabilities with structural conformity checks comprising at least one of:
regex validation for policy numbers;
chronological ordering validation ensuring that an expiry date associated with a policy occurs after a corresponding effective date; and
currency and unit normalization for coverage limits and deductibles in accordance with defined locale-specific rules.

7. The method of claim 1, wherein the canonical policy schema defines field domains, cardinalities, and foreign key relationships among Policy, CoverageItem, Endorsement, and InsuredParty entities, and maintains versioned snapshots of each policy record.

8. The method of claim 1, wherein the bounded error reconciliation routine selects table-extracted values over free-text values when a confidence separation Δ between the two sources exceeds a defined threshold and unit consistency is satisfied, and otherwise marks the field for human review via the human-in-the-loop interface.

9. The method of claim 8, wherein the human-in-the-loop interface prioritizes fields for human correction based on an expected error reduction score computed from field-level confidence and downstream impact on claims processing or recommendations, and stores user corrections as labeled training examples for continuous improvement of the defined document ingestion pipeline.

10. The method of claim 1, wherein assembling the machine-readable claims packet further comprises generating a Merkle root over packet sections and anchoring the Merkle root on a distributed ledger, with inclusion proofs transmitted to the carrier API.

11. The method of claim 10, further comprising:
receiving, from at least one individual device, an individual encryption key;
encrypting the structured policy data and insurance documents using the individual encryption key; and
storing the encrypted structured policy data and the encrypted insurance documents in the encrypted policy vault.

12. The method of claim 1, further comprising:
receiving, by the processing device, a selection of one or more preconfigured compliance rule groups, wherein each compliance rule group corresponds to a defined set of insurance verification requirements associated with at least one of: Fannie Mae property and flood guidelines, Freddie Mac eligibility criteria, the Real Estate Settlement Procedures Act (RESPA) escrow and disclosure requirements, Consumer Financial Protection Bureau (CFPB) force-placed insurance and notice requirements, applicable state-level licensing and minimum coverage regulations, or master policy and homeowners association requirements for planned unit developments, condominiums, or cooperatives; and
applying, by the processing device, the selected compliance rule groups to the normalized structured policy data to determine whether policy attributes satisfy the verification requirements defined by each selected compliance rule group.

13. The method of claim 12, further comprising generating, by the processing device, a structured insurance verification report that:
identifies, for each selected compliance rule group, policy attributes that fail to satisfy the corresponding verification requirements;
explicitly identifies deficiencies, discrepancies, or non-conforming policy attributes with reference to the compliance rule group from which each deficiency arises;
generates one or more remediation recommendations associated with each identified deficiency, wherein each remediation recommendation specifies a corrective action to bring the policy into conformance with the applicable verification requirement; and
presents the structured insurance verification report through a user interface that displays compliance status, identified deficiencies, and remediation recommendations in a format navigable by a user.

14. The method of claim 1, further comprising providing, by the processing device, an asset vault process flow implemented through a mobile application configured to:
capture incident-related information associated with an asset, including image data, video data, receipt data, and audio descriptions, with guided user prompts during documentation;
encrypt the captured image data, video data, receipt data, and audio descriptions upon acquisition using an individual encryption key and store the encrypted data in the encrypted policy vault;
synchronize the encrypted data across authenticated devices associated with authorized users; and
categorize captured receipts, associate the receipts with corresponding incidents or assets, and compute related expense data.

15. The method of claim 14, further comprising:
analyzing the captured image data, video data, receipt data, and audio descriptions using at least one AI analysis engine to determine a damage classification, an incident category, and an estimated cost of damage;
processing the audio descriptions using a natural language processing engine to extract structured incident information and generate a machine-readable incident report;
calculating an impact score representative of incident severity and generating recommendations for claims initiation or asset protection;
enabling controlled access to the stored encrypted data by one or more verified users via role-based permissions;
maintaining an immutable, time-stamped log of interactions with the asset vault using cryptographic hashing; and
cross-referencing asset vault data with the structured policy data and claims data to generate unified incident records for integrated retrieval and reporting.

16. The method of claim 1, further comprising analyzing, by the processing device, a plurality of insurance quote documents using an AI-powered quote comparison module comprising a large language model trained with chain-of-thought prompting to:
extract insurance policy attributes including at least policy tenure, premium cost, coverage limits, deductible values, exclusions, and special clauses using structured data parsing and unstructured text processing;
evaluate and infer relationships among the extracted insurance policy attributes; and
generate a comparative summary identifying differences and similarities across the plurality of insurance quote documents.

17. The method of claim 16, further comprising:
presenting the comparative summary via a user interface in a ranked format based on user-defined preferences;
determining one or more recommended insurance options based on the extracted insurance policy attributes and the user-defined preferences, each recommended insurance option including an associated rationale derived from chain-of-thought reasoning; and
updating one or more parameters of the large language model based on user feedback to improve subsequent recommendations.

18. The method of claim 1, further comprising providing, by the processing device, an AI-powered conversational interface employing agentic AI configured to enable a user to retrieve and query insurance policy information, identification documents, or asset information using natural language input.

19. The method of claim 18, wherein the agentic AI retrieves, from a policy and document repository, information relevant to a received natural language query and generates, using a large language model, concise and contextually appropriate responses for display within the conversational interface.

20. The method of claim 19, wherein the conversational interface maintains dialog context across multiple user turns to support iterative, multi-step interactions and follow-up questions.

21. The method of claim 20, further comprising securing, by the processing device, all conversational interactions through end-to-end encryption and user authentication implemented via biometric verification or voice matching.

22. The method of claim 21, further comprising generating, by the agentic AI, proactive notifications and recommendations to the user regarding insurance policy expiration, coverage adequacy, or potential policy adjustments based on the user profile and the IoT telemetry.

23. The method of claim 22, further comprising storing, by the processing device, a structured log of user interactions with the conversational interface, wherein each log entry is converted into a training instance for continuous improvement of the conversational interface with respect to intent recognition and contextual accuracy.

24. A system comprising:
a communication device configured to receive individual information from at least one individual device associated with an individual, the individual information including health information from a health monitoring device worn by the individual, and further configured to receive Internet-of-Things (IoT) telemetry including at least one of smart home sensor events or telematics data;
a processing device configured to:
analyze the individual information using at least one machine learning model to assess risk associated with at least one of an asset of the individual or the individual, and generate a risk profile indicating exposure to the risk;
determine, based on the risk profile, at least one insurance requirement and facilitate interaction between the individual and at least one of an insurance provider or an insurance broker via established communication links;
execute a defined document ingestion pipeline that:
performs template detection using a supervised classifier trained on learned layout features including logo embeddings and page layout signatures;
performs optical character recognition (OCR) with language model constrained decoding biased to insurance domain lexicons;
aligns OCR tokens to schema fields via a dynamic programming cost function combining edit distance, spatial proximity, and language model likelihood;
parses coverage tables using XY cut segmentation with header normalization;
computes field-level confidence scores from token posteriors and structural conformity checks;
normalizes extracted values into a canonical policy schema with defined field constraints and relationships;
stores the canonical policy schema with associated field-level confidence annotations and lineage metadata linking each field value to a corresponding source segment and extraction method;
applies a bounded error reconciliation routine that resolves conflicts between free-text and table extractions using deterministic precedence rules conditioned on confidence separation; and
surfaces, via a human-in-the-loop interface, fields with confidence scores below a threshold for human correction, wherein user corrections are stored as labeled examples for continuous model improvement;
compute, via a risk profiling engine, a multidimensional score based on structured policy data, a user profile, asset data, and the IoT telemetry; and
assemble, via a claims orchestration service, a machine-readable claims packet for first notice of loss (FNOL) using normalized policy fields and incident evidence, and file the claims packet via a carrier API;
a storage device configured to store insurance documents and the structured policy data in an encrypted policy vault;
wherein the defined document ingestion pipeline reduces field extraction error by at least 20% and reduces end-to-end ingestion latency by at least 15% relative to a baseline OCR and pattern matching approach across heterogeneous insurer templates.

25. The system of claim 24, wherein the supervised classifier comprises a convolutional encoder producing logo embeddings concatenated with a layout fingerprint vector to form a template signature.

26. The system of claim 24, wherein the OCR component uses subword language models for constrained decoding with a configurable beam width to balance accuracy and latency.

27. The system of claim 24, wherein the dynamic programming token alignment employs anchor detection for field labels and enforces adjacency constraints to reduce cross-field token swaps.

28. The system of claim 27, wherein the XY cut segmentation applies recursive partitioning until region entropy or minimum text density thresholds are met, and confirms table regions via column alignment scoring.

29. The system of claim 28, wherein header normalization maps synonymous headers to a controlled vocabulary including at least mappings for “BI,” “PD,” “UM,” “UIM,” “Comp. ,” “Collision,” and “Ded.”

30. The system of claim 24, wherein the processing device is further configured to compute field-level confidence scores by combining token posterior probabilities with structural conformity checks comprising at least one of:
regex validation for policy numbers;
chronological ordering validation ensuring that an expiry date associated with a policy occurs after a corresponding effective date; and
currency and unit normalization for coverage limits and deductibles in accordance with defined locale-specific rules.

31. The system of claim 24, wherein the bounded error reconciliation routine selects table-extracted values over free-text values when a confidence separation Δ exceeds a defined threshold and unit consistency is satisfied, and otherwise marks the field for human review via the human-in-the-loop interface.

32. The system of claim 31, wherein the human-in-the-loop interface prioritizes fields for human correction based on an expected error reduction score computed from field-level confidence and downstream impact on claims processing or recommendations, and stores user corrections as labeled training examples for continuous improvement of the defined document ingestion pipeline.

33. The system of claim 24, further comprising a mobile interface configured to implement an asset vault process flow, the mobile interface being further configured to:
capture encrypted image data, video data, receipt data, and audio descriptions associated with asset documentation;
synchronize the encrypted image data, video data, receipt data, and audio descriptions across authenticated devices associated with authorized users; and
categorize captured receipts and associate the receipts with corresponding assets or incidents.

34. The system of claim 33, further comprising an AI analysis engine configured to integrate computer vision, natural language processing (NLP), and structured receipt OCR models to assess damage and categorize documented incidents based on the captured image data, video data, receipt data, and audio descriptions.

35. The system of claim 33, wherein the mobile interface is further configured to synchronize encrypted vault data across multiple authenticated accounts associated with authorized family members.

36. The system of claim 24, further comprising a chain-of-thought (CoT) prompted large language model (LLM) quote comparison module configured to automatically extract, compare, and summarize insurance policy attributes from a plurality of received insurance quote documents.

37. The system of claim 36, wherein the CoT-prompted LLM quote comparison module is further configured to display comparative results through a graphical dashboard highlighting differences in premium amounts, deductible levels, and coverage limits.

38. The system of claim 24, further comprising an AI conversational gateway employing agentic AI configured to interpret natural language queries relating to stored insurance policies and asset records.

39. The system of claim 38, wherein the AI conversational gateway maintains persistent conversational context and dynamically generates responses based on information retrieved from the structured policy data and document repositories.

40. The system of claim 24, further comprising a federated learning data management module configured to log user interactions across the mobile interface, the CoT-prompted LLM quote comparison module, and the AI conversational gateway as structured training data for AI model improvement.

41. The system of claim 40, wherein the federated learning data management module implements privacy-preserving model updates using secure aggregation protocols including at least one of homomorphic encryption, secure multi-party computation, or differential privacy, to ensure that no raw user data is transmitted beyond local devices during distributed training.
